(19) United States
(12) Patent Application Publication
(10) Pub. No.: US 2004/0133654 A1
(43) Pub. Date: Jul. 8, 2004

(54) Method for adding sound via a telephone network to a page of data that can be remotely consulted via a communication network, site, voice server and computer using said method

(76) Inventors: Hubert Caire, Marseille (FR); Julien Sabdes, Chateuneuf Les Martigues (FR)

Correspondence Address: Oliff & Berridge, P O Box 19928, Alexandria, VA, 22320, US

(21) Appl. No.: 10/470,844

(22) PCT Filed: Jan. 31, 2002
(86) PCT No.: PCT/FR02/00378

(30) Foreign Application Priority Data
Jan. 31, 2001 (FR) 01/01336

(51) Int. Cl. G06F 15/16

(52) U.S. Cl. 709/218

(57) ABSTRACT

The invention relates to a method for adding sound to a page of data that can be remotely consulted via a communication network (9). Said method consists in establishing a telephone communication with a visitor to the page and transmitting sound via the telephone communication to said visitor, the emission of said sound being triggered by the visitor navigating the page of data The invention also relates to a site, voice server and computer using said method.

The present invention relates to a method of providing sound effects for a data page that can be consulted remotely via a communication network, the invention also relates to a website, to a voice server, and to a computer implementing the method.

Data pages that can be consulted over the Internet are known, and they are commonly referred to as “websites”. These data pages contain text, animated or still pictures, and sometimes sounds.

The development of websites that deliver sound in real time is limited at present by the low data rate of most Internet connections. Compacting algorithms like those in the motion picture experts group (MPEG) family enable software means to increase the efficiency of lines, but generally in proportions that are insufficient and at the cost of computations that require large computer resources, so the computer must be quite powerful. In addition, external modules known as “plug-ins” often need to be downloaded in order to execute such algorithms.

Faced with this problem, some publishers seeking to provide their websites with sound effects in spite of the data rate limitations have contented themselves with using sounds of poor quality, compatible with relatively low data rates.

The present invention seeks to propose a solution for providing a website with sound effects that enables high quality sound to be broadcast without overloading the network giving access to the website.

The present invention provides a method of providing sound effects for a data page that can be consulted remotely via a communication network, the method being characterized in that it consists in setting up a telephone call with a user of the page and in using the telephone call to convey sounds to the user, with the transmission of said sounds being triggered by the user's navigation over the data page.

This method is advantageous in that it does not consume any of the resources of the computer used for navigating the data page, and above all in that it does not occupy capacity in the line giving access to the communication network, which line serves to transfer only text or pictures.

Thus, whatever kind of connection is used to the communication network, any user to the data page can receive, over the telephone, the sound associated with the events which occur on the data page while navigating it.

In a particular implementation of the invention, the telephone call set up with the user of the data page serves not only to deliver sounds to the user, but also to return sounds transmitted by the user.

In particular, the telephone can be used by the publisher of the website as a microphone for recording sounds for broadcasting to users. The publisher can thus parameterise the website remotely by modifying the sounds associated with different zones of the pages on the website.

In a particular implementation of the invention, the sounds transmitted by a first user on a first telephone call are directed to a second telephone call set up by a second user, and the sounds transmitted by the second user on the second telephone call are directed to the first telephone call. In other words, the two users are interconnected telephonically by the server.

By means of this possibility, the method of the invention can be used in a large number of Internet server applications. For example the website can be a telephone inquiry website: a user connects to the telephone home website of a business or an official body and seeks to find a particular service or third party. By navigating the website, the user runs through menus corresponding to various departments of the organization and finds a mention of the desired destination. While navigating, the user is guided not only by visual information displayed on the screen, but also by sound information synchronized therewith and received by telephone. Once the destination has been found, the user's telephone can be put through to that destination by clicking on a link, thereby causing the telephone call to be transferred to the corresponding telephone extension.

Another application for the invention is that of putting users into computer with each other: users who need not necessarily know each other connect with a website in order to get in touch. Each user sets out a problem for solution, hoping that some other user will be simultaneously present on the website and can provide that solution. Any user can consult a list of currently-connected users and the problems they are submitting. Users who believe they can help other users can enter directly into telephone computer with such another user via the website by clicking the corresponding link. By means of the method of the invention, users do not need to reveal their own telephone numbers.

The invention provides websites that offer these facilities.

In a particular implementation of the invention, a user's access to a data page depends on the user making a telephone call to a particular number. By using a special charge rate number, the invention enables the producer of the data page to be remunerated, by benefiting from shared telephone call charging (revenues are shared between the telephone operator and the service provider). Access to a website can thus be paid for without resorting to traditional methods of remote payment by bank card or by directly debiting a bank account, while still providing a paid-for service that is made available without prior subscription.

The invention also provides a website accessible via a communication network, the website being characterized in that it comprises at least one page including sound to be sent over a telephone call.

In a particular embodiment, the website comprises an identification page inviting an user of the website to dial a telephone number on a telephone line in order to set up said telephone call.

The invention also provides a voice server suitable for being connected firstly to the public switched telephone network and secondly to a public communication network, the server being characterized in that it comprises means for receiving a request via the public communication network from another server hosting a data page, means for setting up a telephone call with an user of the data page, and means for responding to said request by transmitting over said telephone call sounds determined by said request.

Finally, the invention provides a computer hosting a voice server as described above.

The invention will be better understood on reading the following description, given purely by way of example and made with reference to the accompanying drawings, in which:

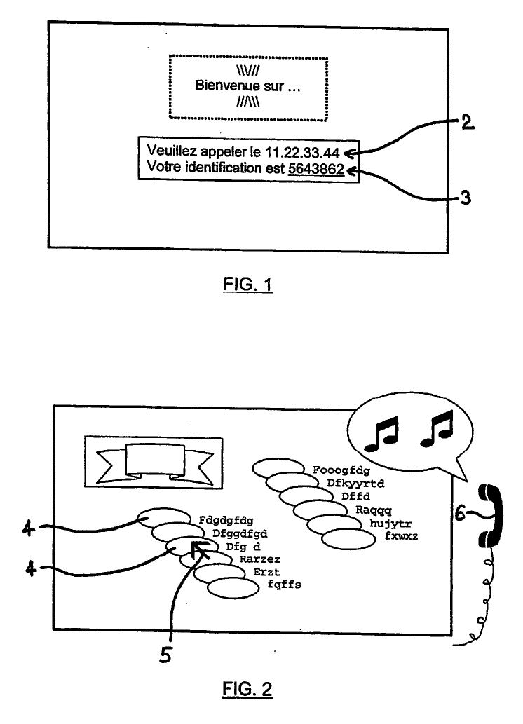

FIG. 1 shows a home page for a website of the invention

FIG. 2 shows a later page of the FIG. 1 website and the telephone set of an user;

FIG. 3 is a diagram showing two servers, the personal computer and the telephone of a user, a computer network, and the public switched telephone network (PSTN); and

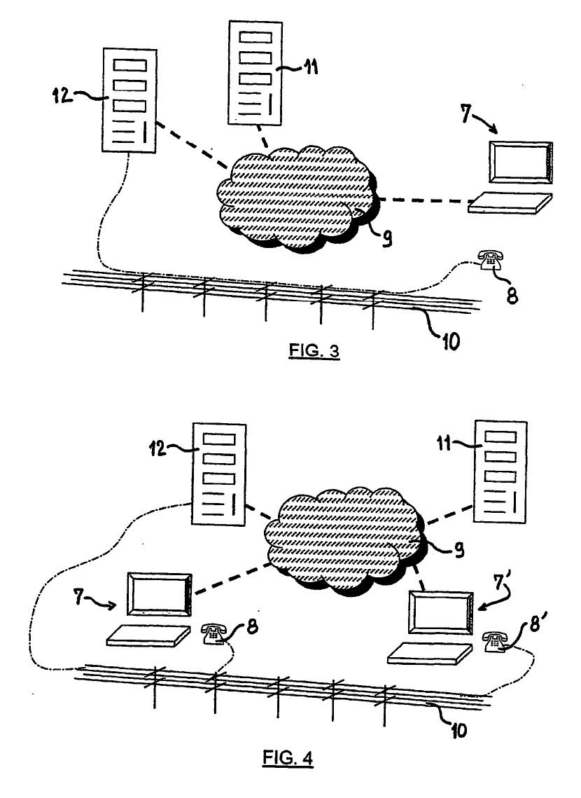

FIG. 4 is a diagram showing two servers, the personal computers and the telephones of two users, the computer network, and the PSTN.

FIG. 1 shows a home page 1 of a website where an user is invited to dial a telephone number 2 in order to make a further connection to the website via a telephone link. The user is shown the telephone number to dial together with an ID number 3 given to the user by the server on making initial contact with the website.

The ID number 3 is used for associating the telephone call (made over the public switched telephone network (PSTN)) that is to be set up between the user and the server of the website, and the already set up connection (over a public communication network such as the Internet) between the computer and the server of the website.

Another method of identifying the user consists in giving the user an ID number over the telephone and inviting the user to key that number into a form on the home page of the website. As mentioned above, the telephone call and the connection set up between the user's computer and the server of the website are associated by means of the ID number.

FIG. 2 shows an example of a page of the website which has active zones 4. When the user moves the mouse pointer 5 onto an active zone and clicks, that causes sounds to be transmitted which provide comments about the images superposed on the active zones.

All of these sounds reach the user over the telephone call and thus go to the user's telephone 6; they are not sent over the computer network for execution by the user's computer.

FIG. 3 is an overall view of a system enabling a user to navigate a website that implements the invention.

The user has a personal computer 7 and a personal telephone 8. The user's personal computer 7 is connected to the public computer network 9 referred to below as the “Internet”, while the telephone is connected to the PSTN 10.

A first computer constituting an Internet server 11 hosts the website which the user seeks to explore. This Internet server can belong to the publisher of the website or to a separate host. In any event, the content of the website is administered by a Webmaster acting on behalf of the website publisher.

A second computer 12 serves to implement the invention by acting firstly as a voice server (for which purpose it is connected to the PSTN), and secondly as an Internet server controlling access to the website (and for this purpose it is connected to the Internet in order to communicate with the first server).

There follows a description of the sequence of operations that takes place when a user accesses a website hosted by the first server and visits that website.

Using the navigator program running on the personal computer 7, the user specifies the address of the home page of the website, which home page is situated in the public portion of the website.

This home page mentions the telephone number to be dialed in order to connect to the website.

Depending on whether the ID number (which can also be referred to as a “password”) is provided by being displayed on the user's personal computer 7 or is provided by a voice message sent over the telephone 8, two authentication methods can be contrasted.

If identification is provided by a display on the screen of the user's personal computer 7, then the following steps are executed:

when the user's personal computer connects to the home page of the website, the first server 11 notifies the second server 12 that a new user is proposing to visit the website;

the second computer 12, as the Internet server controlling access to the website, creates a new account for this user who is possibly about to visit the website, and allocates an ID number, which number is sent to the first server over a point-to-point link via the Internet;

the first server 11 redirects the user to a page situated in the private portion of the website, giving the telephone number to be dialed and the ID number allocated by the second server; an example of such a page is provided in FIG. 1;

the user uses the keypad on the telephone 8 to dial the number specified by the website and thus sets up a telephone call with the voice server of the second computer; on the invitation of the voice server, the user dials the ID number displayed on the computer screen, again using the telephone keypad;

the second computer 12 compares the number dialed in this way with the ID number allocated to the user and uses a point-to-point Internet connection to deliver website access authorization to the first server; and

the user can then begin to navigate as described below.

If identification is supplied to the user by telephone, then the steps are as follows:

the home page of the website gives not only the telephone number to be dialed for connection to the website, but also displays a form into which the user can enter a log-in and a password;

the user dials the telephone number and sets up a telephone call with the voice server of the second server;

the voice server of the second server supplies the user with a log-in which is allocated dynamically and the user then fills in the form on the screen of the computer, specifying the log-in that has just been given over the telephone, together with a password selected by the user;

the user then sends the form as filled in this way to the first server;

the first server 11 then uses a point-to-point Internet link to send a request to the second server 12 specifying the log-in and the password as input by the user; and

the second server 12 uses a point-to-point link to the first server to return authorization to access the website after verifying that the log-in is indeed the same as indicated over the telephone to the user.

Once authorization has been granted, and regardless of the way in which access is controlled, the user can penetrate into the private portion of the website and navigate its pages. While navigating, the actions of the user can trigger the transmission of sounds. These sounds reach the user via the telephone line as follows.

In a page of the website, at locations that correspond to audio messages, calls are programmed using a script available on the second server 12. This script accepts as parameters the user's log-in and a list of commands with their own parameters. Each call triggers execution of the script on the second server and this execution of the script gives rise to the voice server transmitting sound over the telephone call set up with the user's telephone 8.

If the second server is dedicated to a single website only, then the user's log-in ID suffices to generate access to the sound effects of the website, as mentioned above.

However, if the second server is used by several websites, possibly hosted on different first servers, which is the general case, then an authentication key is necessary to identify the website concerned. Under these conditions, the second server 12 manages a database which references all of the websites whose access and sound effects are managed by said second server.

The authentication key is thus used together with the log-in whenever checking user access to websites and also whenever transmitting audio while the websites are being navigated.

Examples of commands that can be executed by the audio control script on the second server are the following:

the command “delay” which acts as a modifier, specifying the maximum duration of forthcoming recordings in seconds;

the command “duo” which sets up a telephone call between the present user and some other person whose log-in is passed as a parameter;

the command “erase” which deletes the file whose name is given as a parameter;

the command “play” which plays the sound file whose name is passed as a parameter using synchronous reading, i.e. the following command is read only after reading of the file has terminated;

the command “record” which records the sound file whose name is passed as a parameter; the maximum duration of the recording being specified by the command “delay”; and

the command “spell” which causes the string passed as a parameter to be spelt out, said string being made up solely of letters and digits.

It can be seen that the second server 12 is involved in two different ways in website management. Firstly the second server controls access to the website by providing an ID number (or log-in) which guarantees that the user has properly set up a telephone call when accessing the website; and secondly it emits the sounds which provide the sound effects for the website and serves to reduce traffic over the connection passing via, the Internet.

In the example of FIG. 4, there can be seen the two computers 11 and 12 already shown in FIG. 3 together with the personal computers 7 and 7′ and the personal telephones 8 and 8′ of two users. Each user is connected to the website hosted by the first server using the procedure described above.

The above-mentioned command “duo” enables the two users to enter into a telephone call with each other via their telephones 8, 8′ and the voice server, while they are navigating the website.

Naturally, the embodiments described above are given purely by way of indication and do not imply any limitation on the scope of the invention which is defined by the accompanying claims.

1/ A method of providing sound effects for a data page that can be consulted remotely via a communication network (9), the method being characterized in that it consists in setting up a telephone call with a user of the page and in using the telephone call to convey sounds to the user, with the transmission of said sounds being triggered by the user's navigation over the data page.

2/ A method according to claim 1, characterized in that the telephone call set up with the user of the data page serves not only to convey sounds to the user, but also to receive sounds transmitted by the user.

3/ A method according to claim 1 or claim 2, characterized in that the sounds transmitted by a first user on a first telephone call are directed to a second telephone call set up by a second user, and in that the sounds transmitted by the second user on the second telephone call are directed to the first telephone call.

4/ A method according to any one of claims 1 to 3, characterized in that the user's access to the data page is conditioned by the user setting up a telephone call to a particular number.

5/ A website accessible via a communication network (9), the website being characterized in that it comprises at least one page including sound to be sent over a telephone call.

6/ A website according to claim 5, characterized in that it comprises an identification page inviting a user of the website to dial a telephone number (2) on a telephone line in order to set up said telephone call.

7/ A telephone guidance website for a business or a public body according to claim 5 or claim 6, to which website a user can make a connection over a public communication network (9) in order to reach a particular service or third party, wherein the user can scroll through menus corresponding to various departments of the business by navigating over the website and can find an indication of the desired destination, and can then be put into telephone communication with that destination by clicking on a link, thereby causing the telephone call to be transferred to the destination telephone extension.

8/ A website for putting users into touch with one another according to claim 5 or claim 6, various users being able to connect to the website via a public communication network (9) in order to get into touch, each user specifying a problem for which the user desires a solution in the hope that another user is simultaneously present on the website and capable of providing such a solution, all users being able to consult a list of connected users and the problems they are submitting, and any user of the opinion that he or she can provide assistance to another user being capable of entering directly into a telephone call with that user via the website, by clicking on the corresponding link.

9/ A voice server (12) suitable for being connected firstly to the public switched telephone network (10) and secondly to a public computer network (9), the server being characterized in that it comprises means for receiving a request via the public computer network from another server hosting a data page, means for setting up a telephone call with a user of the data page, and means for responding to said request by transmitting sounds determined by said request over said telephone call.

10/ A computer (12) hosting a voice server according to claim 9.
